(19) United States
(12) Patent Application Publication
(10) Pub. No.: US 2010/0284359 A1
(43) Pub. Date: Nov. 11, 2010

(54) METHOD AND APPARATUS FOR TRANSMITTING/RECEIVING DOWNLINK DATA IN WIRELESS COMMUNICATION NETWORK

(75) Inventors: Dong-Hee Kim, Gyeonggi-do (KR); Hwan-Joon Kwon, Gyeonggi-do (KR); Jae-Chon Yu, Gyeonggi-do (KR); Yeon-Ju Lim, Seoul (KR); Cheol Mun, Chungbuk (KR); Jong-Gwan Yook, Seoul (KR)

Correspondence Address: THE FARRELL LAW FIRM, LLP, 290 Broadhollow Road, Suite 210E, Melville, NY, 11747, US

(73) Assignees: Samsung Electronics Co., Ltd., Gyeonggi-do (KR); Industry-Academic Cooperation Foundation ,Yonsei U, Seoul (KR)

(21) Appl. No.: 12/810,955

(22) PCT Filed: Dec. 26, 2008
(86) PCT No.: PCT/KR2008/007712

§ 371 Date: Jun. 28, 2010

(30) Foreign Application Priority Data
Dec. 28, 2007 (KR) 10-2007-0140142
Feb. 14, 2008 (KR) 10-2008-0013704

(51) Int. Cl. H04W 72/12; H04L 27/28

(52) U.S. Cl. 370/329; 375/260

(57) ABSTRACT

Disclosed is C-SDMA and C-BF technology for effectively suppressing inter-cell interference from neighboring BTSs only by using partial channel information delivered from an AT over a limited uplink feedback channel in a collaborative wireless communication system employing an FDD scheme and including neighboring BTSs connected to each other through a high-speed wireline communication network. C-SDMA technology makes it possible to select the optimal feedback scheme by considering uplink feedback channel capacity allowed in the system. C-BF technology uses information on beamforming signal weight and main beamforming interference weight vectors to suppress collision between formed by weights that each BTS uses, thereby improving system transmission capacity. Technology providing higher system capacity is adaptively selected from among C-SDMA and C-BF by using limited feedback information, so that high system capacity is provided in various environmental conditions.

### BACKGROUND OF THE INVENTION

1. Field of the Invention

The present invention relates to a wireless communication system using a multiple-input multiple-output antenna array, and more particularly to a method and apparatus for collaboratively transmitting/receiving data between base stations to transmit downlink data.

2. Description of the Related Art

In order to provide high-quality data services in wireless communication, there is proposed a multiple-input multiple-output antenna system (hereinafter referred to as “MIMO”) in which multiple antennas are used at transmitting and receiving ends respectively. Spatial multiplexing (SM) technology that is a type of MIMO technology can increase data transmission capacity at each link by simultaneously forming a plurality of spatial subchannels between one transmitter and one receiver to independently transmit data according to the respective spatial subchannels. Also, space division multiple access (SDMA) technology can the transmission capacity of a system by simultaneously transmitting data to a plurality of receivers.

In a system employing SM technology and SDMA technology, spatial signal processing is required of a transmitter and a receiver, and to this end, the transmitter and the receiver must have MIMO channel state information (CSI) between them. Particularly, in order to apply SM technology and SDMA technology operating in downlink, a base transceiver station (BTS) must have MIMO CSI from n_{T} transmit antennas of the BTS to n_{R} receive antennas of an access terminal (AT).

Since a frequency division duplexing (FDD) system uses different frequency bands in downlink and uplink, an AT must estimate an downlink channel and feed back the CSI of the estimated downlink channel (downlink CSI) to a BTS so that the BTS has the downlink CSI. However, transmission of a lot of uplink information is required to feed back full CSI to a BTS, and thus multiple antenna technology for effectively applying SM technology and SDMA technology only by using minimum feedback information have been proposed.

FIG. 1 illustrates conventional multiple antenna technology.

As illustrated in FIG. 1, conventional multiple antenna technology focuses on spatially removing or suppressing intra-cell interference that is interference between data streams simultaneously transmitted within the same cell. Particularly, in conventional SDMA technology, n_{T} beams are formed for each BTS, and each BTS independently performs scheduling in order to select an AT to which to transmit data through each beam. However, when the ATs selected by independent scheduling of each BTS are located in a region where service areas of neighboring BTSs overlap, inter-cell interference significantly increases, which results in deterioration of service reception performance. To improve this drawback, a need has recently been identified for research on network MIMO technology or collaborative MIMO technology to suppress inter-cell interference (ICI) as well as intra-cell interference.

FIG. 2 is a view for explaining the concept of collaborative SDMA technology to which the present invention is applied.

In collaborative SDMA technology, neighboring BTSs that may give inter-cell interference to each other are connected to a cluster scheduler 210 through a high-speed broadband wireline communication network. Each BTS delivers channel information fed back by ATs to the cluster scheduler 210 over the wireline communication network, and the cluster scheduler 210 performs scheduling for all ATs belonging to the corresponding cluster by considering intra-cell interference and inter-cell interference. The cluster scheduler 210 informs each BTS scheduler of ATs to which to transmit data from the corresponding BTS selected by scheduling, weight information to be used by each corresponding AT, and modulation and coding scheme (MCS) information of data to be transmitted to each corresponding AT. Each BTS scheduler finally determines ATs to which transmit data from the corresponding BTS, a weight to be used by each corresponding AT, and an MCS of data to be transmitted to each corresponding AT by making reference to the information delivered from the cluster scheduler 210, and then transmits data to the ATs according to the determined information.

In order to apply collaborative SDMA technology in an FDD wireless communication network, scheduling technology for effectively suppressing inter-cell interference only by using partial channel information delivered from an AT over a limited uplink feedback channel and SDMA technology therefor are required. Also, collaborative ATs (C-ATs) are mingled with non-collaborative ATs (NC-ATs) in a wireless communication network. Here, the C-AT refers to an AT to which collaborative MIMO technology can be applied because it exists in a region where service areas of neighboring BTSs overlap, and the NC-AT refers to an AT to which collaborative technology cannot be applied because it exists in the service area of a single BTS. Therefore, there is a need for collaborative scheduling technology and SDMA technology that can be applied to both C-ATs and NC-ATs. That is, there is a need for collaborative scheduling technology and SDMA technology for C-ATs, which are compatible with existing scheduling technology and SDMA technology for application to NC-ATs.

### SUMMARY OF THE INVENTION

Accordingly, the present invention has been made to solve at least the above-mentioned problems occurring in the prior art, and the present invention provides a new data transmission/reception method and apparatus for collaborative SDMA technology and collaborative beamforming (BF) technology to suppress inter-cell interference from neighboring BTSs only by using partial channel information delivered from an AT over a limited uplink feedback channel in a collaborative wireless communication system employing an FDD scheme and including neighboring BTSs connected to each other through a high-speed wireline communication network.

Further, the present invention provides a method and apparatus for collaborative SDMA technology completely compatible with existing non-collaborative SDMA technology, which can be applied to both NC-ATs existing in the exclusive service area of a single BTS and C-ATs existing in a region where service areas of multiple BTSs overlap.

Further, the present invention provides a method and apparatus for selecting a cluster transmission mode for collaborative SDMA technology and optimizing a feedback scheme according to an uplink feedback channel capacity allowed in the system.

Further, the present invention provides a method and apparatus for adaptively selecting technology providing high system capacity from among collaborative SDMA technology and collaborative BF technology according to the number of collaborative ATs and channel environment caused from interference BTSs by using limited feedback information.

In accordance with an aspect of the present invention, there is provided a method of receiving downlink data in a wireless communication system using a multiple-input multiple-output (MIMO) antenna array, the method including the steps of estimating a downlink channel from a plurality of base stations; selecting a transmission mode consisting of a combination of precode matrices used by the respective base stations, which maximizes a signal-to-noise ratio in the estimated downlink channel, and feeding back the selected transmission mode and the signal-to-noise ratio in the case of using the selected transmission mode to a corresponding base station; and receiving the downlink data from the corresponding base station.

In accordance with another aspect of the present invention, there is provided a method of transmitting downlink data in a wireless communication system using a multiple-input multiple-output (MIMO) antenna array, the method including the steps of receiving feedback information from access terminals; grouping the access terminals into access terminal groups, each of which includes the access terminals using the same transmission mode, by using transmission modes included in the feedback information, and performing scheduling for each access terminal group; selecting an access terminal group with highest priority determined according to the scheduling, and determining a transmission mode to be used by the access terminals belonging to the selected access terminal group, and a modulation level of the downlink data to be transmitted to the access terminals of the selected access terminal group; and transmitting the downlink data to the access terminals of the selected access terminal group according to the determined transmission mode and modulation level.

In accordance with yet another aspect of the present invention, there is provided a method of receiving downlink data in a wireless communication system using a multiple-input multiple-output (MIMO) antenna array, the method including the steps of estimating a downlink channel from base stations; determining a beamforming signal weight of a base station, which maximize a reception signal-to-noise ratio in the estimated downlink channel, and beamforming interference weights or an interference weight group of interference base stations; feeding back the determined beamforming signal weight and beamforming interference weights and the reception signal-to-noise ratio to a corresponding base station; and receiving the downlink data from the corresponding base station.

In accordance with still yet another aspect of the present invention, there is provided a method of transmitting downlink data in a wireless communication system using a multiple-input multiple-output (MIMO) antenna array, the method including the steps of calculating scheduling priority of access terminals by using signal-to-noise ratios included in feedback information received from the access terminals; performing scheduling in such a manner as to minimize interference between base stations by using the calculated priority and by using a beamforming signal weight of a base station and beamforming interference weights of interference base stations, included in the feedback information; selecting an access terminal to which to transmit the downlink data, and determining a beamforming signal weight and a modulation level to be used by the selected access terminal; and transmitting the downlink data to the selected access terminal according to the determined beamforming signal weight and modulation level.

In accordance with still yet another aspect of the present invention, there is provided an access terminal apparatus for receiving downlink data from a base station in a wireless communication system using a multiple-input multiple-output (MIMO) antenna array, the apparatus including a downlink channel estimator for estimating downlink channels received from base stations; a determiner for selecting a transmission mode maximizing a signal-to-noise ratio according to a result of estimation by the downlink channel estimator; and a feedback transmitter for transmitting information determined by the determiner to the base station over an uplink feedback channel.

In accordance with still yet another aspect of the present invention, there is provided a base station apparatus for transmitting downlink data to access terminals in a wireless communication system using a multiple-input multiple-output (MIMO) antenna array, the apparatus including a feedback receiver for receiving feedback information from the access terminals over an uplink channel; a scheduler for grouping the access terminals into access terminal groups, each of which includes the access terminals using the same transmission mode, by using transmission modes included in the feedback information, selecting an access terminal group with highest priority determined according to the scheduling, and determining a transmission mode to be used by the access terminals belonging to the selected access terminal group, and a modulation level of the downlink data to be transmitted to the access terminals of the selected access terminal group; and a data transmitter for transmitting the downlink data to the access terminals of the selected access terminal group according to the determined transmission mode and modulation level.

### BRIEF DESCRIPTION OF THE DRAWINGS

The above and other objects, features and advantages of the present invention will be more apparent from the following detailed description taken in conjunction with the accompanying drawings, in which:

FIG. 1 is a view illustrating conventional multiple antenna technology;

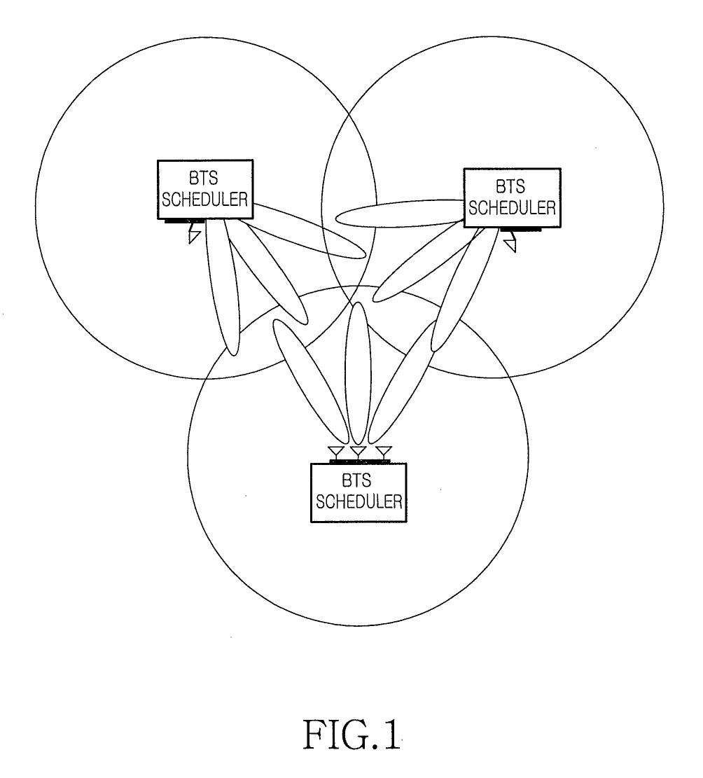

FIG. 2 is a view illustrating C-SDMA technology to which the present invention is applied;

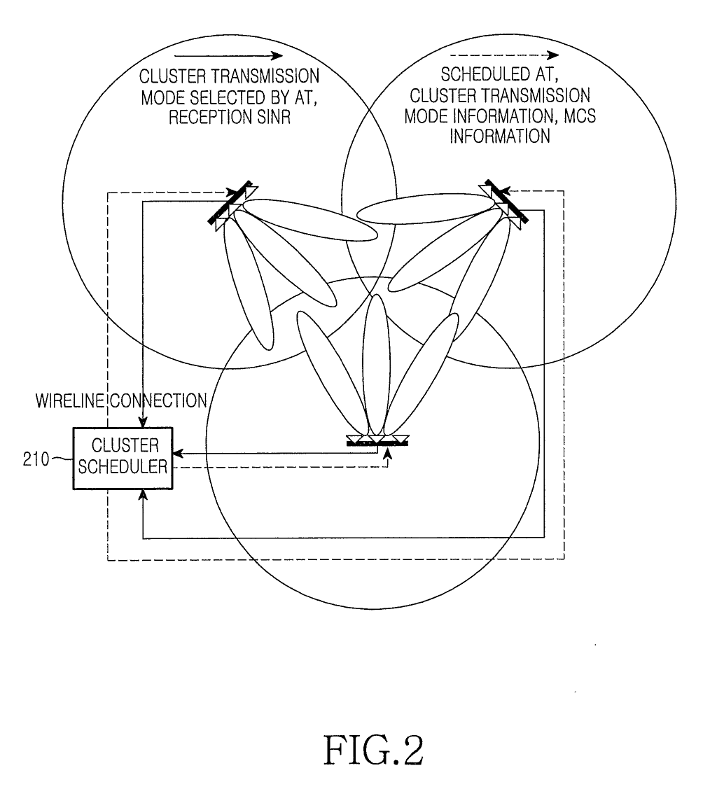

FIG. 3 is a flowchart illustrating an operation of an access terminal in C-SDMA in accordance with an exemplary embodiment of the present invention;

FIG. 4 is a flowchart illustrating an operation of a base station in C-SDMA in accordance with an exemplary embodiment of the present invention;

FIG. 5 is a flowchart illustrating an operation of an access terminal in C-BF in accordance with an exemplary embodiment of the present invention;

FIG. 6 is a flowchart illustrating an operation of a base station in C-BF in accordance with an exemplary embodiment of the present invention;

FIG. 7 is a block diagram illustrating a structure of an access terminal in accordance with an exemplary embodiment of the present invention;

FIG. 8 is a block diagram illustrating a structure of a base station in accordance with an exemplary embodiment of the present invention;

FIG. 9 is a view illustrating performance of C-SDMA technology in comparison to that of NC-SDMA technology in one cluster including K_{c} ATs capable of estimating a downlink channel from three C-BTSs;

FIG. 10 is a flowchart illustrating an operation of an access terminal in hybrid C-SDMA/C-BF in accordance with an exemplary embodiments of the present invention; and

FIG. 11 is a flowchart illustrating an operation of a base station in hybrid C-SDMA/C-BF in accordance with an exemplary embodiment of the present invention.

### DETAILED DESCRIPTION OF THE EXEMPLARY EMBODIMENT

Hereinafter, exemplary embodiments of the present invention will be described with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention. Further, it should be noted that only parts essential for understanding the operations according to the present invention will be described and a description of parts other than the essential parts will be omitted in order not to obscure the gist of the present invention.

The present invention proposes collaborative SDMA (C-SDMA) technology for effectively suppressing inter-cell interference from neighboring BTSs, based on existing SDMA technology using a precoder codebook, in an FDD system.

In consideration of the capacity of an uplink feedback channel, allowed in the system, the present invention enables each AT to select an optimal feedback scheme from among “scheme in which each AT selects only one cluster transmission mode for a BTS to which the AT belongs, and feeds back the selected cluster transmission mode”, “a scheme in which each AT selects as many cluster transmission modes as the number of precoding matrices included in a precoder codebook, G, for a BTS to which the AT belongs, and feeds back the selected cluster transmission modes”, and “a scheme in which each AT selects a cluster transmission mode (single cluster transmission mode) for all M collaborative BTSs, and feeds back the selected cluster transmission mode”. “The scheme in which each AT selects only one cluster transmission mode for a BTS to which the AT belongs, and feeds back the selected cluster transmission mode (single cluster transmission selection scheme)” requires minimum feedback information, but has a disadvantage in that there is a reduction in multiuser diversity gain. Contrarily, “the scheme in which each AT selects as many cluster transmission modes as the number of precoding matrices included in a precoder codebook for a BTS to which the AT belongs, and feeds back the selected cluster transmission modes” and “the scheme in which each AT selects a single cluster transmission mode for all M collaborative BTSs, and feeds back the selected cluster transmission mode” require feedback information amount that is G times and M times as large as that of the single cluster transmission mode selection scheme respectively, but can significantly improve multiuser diversity gain.

Also, in the present invention, an AT feeds back CQI (Channel Quality Information) according to the use of C-SDMA, together with CQI at C-BF transmission, to a BTS over a limited feedback channel, and a cluster scheduler compares collaborative network capacity for each of C-BF and C-SDMA to select and apply technology providing higher capacity.

In embodiments of the present invention, it will be assumed that each BTS uses n_{T} transmit antennas, all ATs use n_{R} receive antennas, a downlink cluster includes three neighboring BTSs, each including K users. However, the present invention is not limited thereto, and may be extended to a cluster including any number of BTSs.

Supposing that xₘ is an (n_{T}*1)-sized transmitted signal vector at the mth BTS, γ_{m,k} is an (n_{R}*1)-sized received signal vector at the kth AT belonging to the mth BTS, and the signal vectors are subjected to frequency non-selective fading, a received signal at the kth AT can be represented by the following equation:

$${y}_{m , k} = \sqrt{\frac{{γ}_{m , k}}{{n}_{T}}} {H}_{m , k} {Fx}_{m} + {\sum }_{i = 1}^{2} \sqrt{\frac{{\overline{γ}}_{m , k , i}}{{n}_{T}}} {\overline{H}}_{m , k , i} {G}_{i} {i}_{i} + {n}_{m , k} \qquad ( 1 )$$

Here, γ_{m,k} denotes an average signal-to-noise ratio (SNR) received from the mth BTS to which the kth AT belongs, γ̅_{m,k,f}, denotes an average SNR received from the ith interference BTS to the ith AT of the mth BTS, H_{m,k} denotes an (n_{T}*n_{R})-sized complex channel matrix received from the mth BTS to which the kth AT belongs, H̅_{m,k,i} denotes an (n_{T}*n_{R})-sized complex channel matrix received from the ith interference BTS to the kth AT of the mth BTS, n_{m,k} denotes an (n_{R}*1)-sized additive white Gaussian noise (AWGN) vector, F and Gᵢ denote an (n_{T}*n_{R})-sized precoding matrix used in the mth BTS and the ith interference BTS respectively, and Iᵢ denotes a signal vector at the ith interference BTS.

Reference will now be made to an operation of an NC-AT In such a C-SDMA system.

When a downlink sounding reference signal received from a BTS is equal to or greater than a reference value, an NC-AT estimates a corresponding downlink channel by using the downlink sounding reference signal. If the NC-AT receives a downlink sounding reference signal transmitted from a BTS to which it belongs, and does not receive a sounding reference signal from interference BTSs in the cluster, then the corresponding NC-AT cannot estimate a downlink channel matrix { H̅_{m,k,i}}_{i=1,2} from the interference BTSs in the cluster, and thus the downlink channel from the interference BTSs is considered pure inter-cell interference. Therefore, the corresponding NC-AT operates in non-collaborative SDMA (NC-SDMA) technology. In this case, the corresponding NC-AT operates in the same manner as in existing precoder codebook-based SDMA technology.

A detailed operation procedure of such an NC-AT is as follows:

The kth NC-AT estimates a downlink channel signal H_{m,k} by using a downlink sounding reference signal transmitted from the mth BTS. Using the estimated downlink channel signal, the NC-AT selects a precoding matrix that maximizes multiuser diversity gain at a link between the mth BTS and the kth AT.

In SDMA technology using a precoder codebook, one precoding matrix maximizing the system capacity of a corresponding BTS is selected from a codebook consisting of G (n_{T}*n_{R})-sized precoding matrices, F={E₁, E₂, . . . , E_{G}} and the selected precoding matrix is used. To this end, an AT calculates the signal-to-interference-and-noise ratio (SINR) of n_{T} transmission data streams for the G precoding matrices belonging to the codebook F. Let W_{m k}=[w_{m,k,1}w_{m,k,2} . . . w_{m,k,n}_{_{T}}] be an (n_{T}*n_{R})-sized reception weight matrix calculated according to a reception algorithm used by the AT. When the AT uses the gth precoding matrix F_{g} of the codebook F, it recovers the nth data symbol {X_{m,k,n}}_{n=1, . . . , n}_{_{T}} of the transmission signal vector xₘ as given in the follow equation:

$${x}_{m , k , n} ( {F}_{g} ) = \sqrt{\frac{{γ}_{m , k}}{{n}_{T}}} {w}_{m , k , n}^{H} {H}_{m , k} {F}_{g} {x}_{m , k , n} + \sqrt{\frac{{γ}_{m , k}}{{n}_{T}}} {\sum }_{i = 1 , i \neq n}^{{n}_{T}} {w}_{m , k , n}^{H} {H}_{m , k} {F}_{g} {x}_{m , k , n} + {\sum }_{i = 1}^{2} \sqrt{\frac{{\overline{γ}}_{m , k , i}}{{n}_{T}}} {w}_{m , k , n}^{H} {\overline{H}}_{m , k , i} {G}_{i} {I}_{i} + {w}_{m , k , n}^{H} {n}_{m , k} \qquad ( 2 )$$

The SINR {ρ_{m,k,n}(F_{g})}_{n=1, . . . , n}_{_{T}} of the symbol \hat{x}_{m,k,n}(F_{g}) recovered according to Equation (2) is given by the following equation:

$${ρ}_{m , k , n} ( {F}_{g} ) = \frac{\frac{{γ}_{m , k}}{{n}_{T}} {\vert {w}_{m , k , n}^{H} {H}_{m , k} {F}_{g} {x}_{m , k , n} \vert}^{2}}{\begin{matrix}\frac{{γ}_{m , k}}{{n}_{T}} {\sum }_{i = 1 , i \neq n}^{{n}_{T}} {\vert {w}_{m , k , n}^{H} {H}_{m , k} {F}_{g} {x}_{m , k , i} \vert}^{2} + \\ {\sum }_{i = 1}^{2} \frac{{\overline{γ}}_{m , k , i}}{{n}_{T}} {\vert {w}_{m , k , n}^{H} {\overline{H}}_{m , k , i} {G}_{i} {I}_{i} \vert}^{2} + {\vert {w}_{m , k , n}^{H} {n}_{m , k} \vert}^{2}\end{matrix}} \qquad ( 3 )$$

Here, the first term of the denominator in Equation (3) represents intra-cell interference caused by (n_{T}−1) data streams simultaneously transmitted from the mth BTS, and the second term of the denominator represents inter-cell interference caused by the downlink channel matrix { H̅_{m,k,i}}_{i=1,2} from the two interference BTSs.

Using the calculated SINR {ρ_{m,k,n}(F_{g})}_{n=1, . . . , n}_{_{T}} the AT determines the precoding matrix F_{g}_{_{m,k}}, which maximizes multiuser diversity gain at the link between the mth BTS and the kth AT, by means of the following equation:

$${F}_{{g}_{m , k}} = arg {max}_{{F}_{g} , g ∈ \{ 1 , … , G \}} {max}_{n = 1 , … , {n}_{T}} {ρ}_{m , k , n} ( {F}_{g} ) \qquad ( 4 )$$

According to Equation (4), the AT selects the precoding matrix that maximizes the SINR of a stream having the highest SINR from among n_{T} streams. The kth AT informs the mth BTS over an uplink feedback channel of the index g_{m,k}ε{1,2, . . . , G} of the selected precoding matrix in the codebook, and the SINR {ρ_{m,k,n}(F_{g})}_{n=1, . . . , n}_{_{T}} for the n_{T} data streams receivable in data transmission using F_{g}_{_{m,k}}. In summary, an AT transmits the following information to a BTS over an uplink feedback channel:

\textcircled{1} Transmission mode information indicating that the AT operates in NC-SDMA and indicating the index g_{m,k}ε{1,2, . . . , G} of a precoding matrix selected by the AT from a codebook including the selected precoding matrix.

\textcircled{2} SINR information for n_{T} data streams received at the AT when the BTS transmits data by using the precoding matrix F_{g}_{_{m,k}} selected by the AT.

Reference will now be made to an operation of a C-AT for C-SDMA according to an exemplary embodiment of the present invention.

When the kth C-AT of the mth BTS can estimate a downlink MIMO channel matrix { H̅_{m,k,i}}_{i=1,2} from neighboring interference BTSs in the cluster, the corresponding C-AT can operate in C-SDMA. This is possible when a sounding reference signal that the corresponding C-AT receives from interference BTSs in the cluster is equal to or greater than a reference value. Thus, when a C-AT is located at a cell edge, the corresponding C-AT operates in C-SDMA. Each BTS receives feedback information on neighboring BTSs for which a downlink channel can be estimated, that is, information on collaborative BTSs (C-BTSs), from C-ATs belonging to the corresponding BTS, and delivers this information to the cluster scheduler. The cluster scheduler synthesizes C-BTS information fed back by the respective C-ATs and delivered by each BTS to finally determine C-ATs that are to receive data in C-SDMA or C-BF technology, and informs each BTS of the determined C-ATs. The C-ATs belonging to the cluster may be classified into an AT operating in non-collaborative technology (hereinafter this AT will be referred to as “NC-AT”), an AT desiring collaborative transmission between two C-BTSs (hereinafter this AT will be referred to as “C²-AT”), and an AT desiring collaborative transmission between three C-BTSs (hereinafter this AT will be referred to as “C³-AT”).

By way of example, the following description will be given based on C-SDMA for C³-AT, including three C-BTSs inclusive of the mth BTS to which the kth AT belongs. That is, it will be assumed that an AT can estimate a downlink MIMO channel from the mth BTS and two neighboring BTSs. If the kth AT of the mth BTS estimates a downlink MIMO channel matrix { H̅_{m,k,i}}_{i=1,2} from two neighboring interference BTSs, then a (3n_{T}*1)-sized signal vector X simultaneously transmitted from 3n_{T} transmit antennas of the BTS cluster including the mth BTS and the two neighboring BTSs is received at the kth AT of the mth BTS as a signal vector Y_{m,k} given by the following equation:

$$\begin{matrix}{Y}_{m , k} = \sqrt{\frac{{γ}_{m , k}}{{n}_{T}}} [ {H}_{m , k} F {α}_{1} {\overline{H}}_{m , k , 1} {G}_{1} {α}_{2} {\overline{H}}_{m , k , 2} {G}_{2} ] X + {N}_{m , k} \\ = \sqrt{\frac{{γ}_{m , k}}{{n}_{T}}} {c}_{m , k} ( F , {G}_{1} , {G}_{2} ) X + {N}_{m , k}\end{matrix} \qquad ( 5 )$$

Here, Y_{m,k} denotes an (n_{R}*1)-sized reception signal vector, N_{m,k} denotes an (n_{R}*1)-sized noise vector, and C_{m,k}(F,G₁,G₂)=[H_{m,k}F α₁ H̅_{m,k,1}G₁ α₂ H̅_{m,k,2}G₂] denotes an (n_{R}*3n_{T})-sized effective downlink channel matrix from the three C-BTSs belonging to the C-BTS cluster to the kth AT of the mth BTS. Since the AT can estimate each of H_{m,k} and {α₁ H̅_{m,k,i}}_{i=1,2} by using the sounding reference signal received from the C-BTSs, it can calculate C_{m,k}(F,G₁,G₂) when it knows the precoding matrix F to be used by the mth BTS and the precoding matrix {Gᵢ}_{i=1,2} to be used by the two interference BTSs. Also, in Equation (5), α₁=\sqrt{γ̅_{k,m,1}/γ_{k,m}}, and α₂=\sqrt{γ̅_{k,m,2}/γ_{k,m}}.

In the end, Equation (5) shows that the precoding matrix F to be used by the mth BTS and the precoding matrix {Gᵢ}_{i=1,2} to be used by the two interference BTSs must be simultaneously determined in such a manner as to maximize multiuser diversity gain at a link from the C-BTS cluster to the kth AT of the mth BTS. Since all the BTSs use one precoding matrix selected from a precoder codebook F={E₁E₂, . . . , E_{G}} consisting of G precoding matrices, the AT selects a precoding matrix combination maximizing multiuser diversity gain from among all G³ possible precoding matrix combinations. In the present invention, each of such precoding matrix combinations is defined as a cluster transmission mode.

For example, when a precoder codebook F={E₁, E₂} consisting of two precoding matrices is used, and the number of C-BTSs is three, eight possible cluster transmission modes (2³=8) for C³-AT are given by the following equation:

(F,G₁,G₂)=(E₁,E₁,E₁),(E₁,E₁,E₂),(E₁,E₂,E₂),(E₂,E₁,E₁),(E₂,E₁,E₂),(E₂,E₂,E₁),(E₂,E₂,E₂) (6)

The kth AT of the mth BTS calculates the reception SINR of n_{T} data streams received from the mth BTS for all the possible cluster transmission modes. Let W_{m,k}=[w_{m,k,1} w_{m,k,2} . . . w_{m,k3n}_{_{T}}] be an (n_{R}*3n_{T})-sized reception weight matrix calculated according to the reception algorithm of a receiver used by the AT. Then, the first to n_{T}th column vectors {w_{m,k,n}}_{n=1, . . . , n}_{_{T}} of W_{m,k} are reception weight vectors for the n_{T} data streams transmitted from the mth BTS. When the AT uses (F_{G}, G_{G}, G_{b}) from among the possible cluster transmission modes, it recovers the symbol {x_{m,k,n}}_{n=1, . . . , n}_{_{T}} of the nth data stream of a signal vector Xₘ transmitted from the mth BTS as given in the following equation:

$${x}_{m , k , n} ( {F}_{G} , {G}_{G} , {G}_{b} ) = \sqrt{\frac{{γ}_{m , k}}{{n}_{T}}} {w}_{m , k , n}^{H} {C}_{m , k} ( {F}_{G} , {G}_{G} , {G}_{b} ) {x}_{m , k , n} + \frac{{γ}_{m , k}}{{n}_{T}} {\sum }_{i = 1 , i \neq n}^{3 \times {n}_{T}} {w}_{m , k , n}^{H} {C}_{m , k} ( {F}_{G} , {G}_{G} , {G}_{b} ) {x}_{m , k , n} + {w}_{m , k , n}^{H} {N}_{m , k} \qquad ( 7 )$$

The SINR {ρ_{m,k,n}(F_{G}, G_{G},G_{b})}ₙ₌₁, . . . n_{_{T}} of the recovered symbol \hat{x}_{m,k,n}(F_{G},G_{G},G_{b}) is given by the following equation:

$${ρ}_{m , k , n} ( {F}_{G} , {G}_{G} , {G}_{b} ) = \frac{\frac{{γ}_{m , k}}{{n}_{T}} {\vert {w}_{m , k , n}^{H} {C}_{m , k} ( {F}_{G} , {G}_{G} , {G}_{b} ) {x}_{m , k , n} \vert}^{2}}{\begin{matrix}\frac{{γ}_{m , k}}{{n}_{T}} {\sum }_{i = 1 , i \neq n}^{3 \times {n}_{T}} {\vert {w}_{m , k , n}^{H} {C}_{m , k} ( {F}_{G} , {G}_{G} , {G}_{b} ) {x}_{m , k , i} \vert}^{2} + \\ {\vert {w}_{m , k , n}^{H} {N}_{m , k} \vert}^{2}\end{matrix}} \qquad ( 8 )$$

Here, the first term of the denominator in Equation (8) represents interference between (3×n_{T}−1) data streams simultaneously transmitted by the C-BTSs.

Using the calculated SINR {γ_{m,k,n}(F_{G},G_{G},G_{b})}_{n=1, . . . , n}_{_{T}} the AT determines the precoding matrix (F_{G},G_{G},G_{b}), which maximizes multiuser diversity gain at the link from the C-BTS cluster to the kth AT of the mth BTS, by means of the following equation:

$$( {F}_{{g}_{m , k}} , {G}_{{I}_{m , k , 1}} , {G}_{{I}_{m , k , 2}} ) = arg {max}_{( {F}_{n} , {G}_{n} , {G}_{k} ) , {F}_{n} , {G}_{n} , {G}_{k} ∈ F} {max}_{n = 1 , … , {n}_{T}} {ρ}_{m , k , n} ( {F}_{a} , {G}_{a} , {G}_{b} ) \qquad ( 9 )$$

According to Equation (9), the AT selects the cluster transmission mode that maximizes the SINR of a stream having the highest SINR from among n_{T} streams transmitted by the mth BTS and received by the kth AT. Here, F_{g}_{_{m,k}}, G_{I}_{_{m,k,1}}, and G_{I}_{_{m,k,2}} are precoding matrices that must be simultaneously used by the mth BTS and the two neighboring interference BTSs respectively in order to maximize multiuser diversity gain at the link from the C-BTS cluster to the kth AT of the mth BTS. The cluster transmission mode (F_{g}_{_{m,k}},G_{I}_{_{m,k,1}},G_{I}_{_{m,k,2}}) is the optimal precoding matrix combination that maximizes channel gain to the kth AT of the mth BTS, and at the same time, minimizes interference from the two neighboring interference BTSs. Thus, the kth AT informs the mth BTS over an uplink feedback channel of the indexes indicating the cluster transmission mode (F_{g}_{_{m,k}},G_{I}_{_{m,k,1}},G_{I}_{_{m,k,2}}) to be used by the C-BTSs belonging to the C-BTS cluster, and the SINR {ρ_{m,k,n}(F_{g}_{_{m,k}},G_{I}_{_{m,k,1}},G_{I}_{_{m,k,2}})}_{n=1, . . . , n}_{_{T}} for the n_{T} data streams received at the kth AT of the mth BTS when transmitted using the cluster transmission mode (F_{g}_{_{m,k}},G_{I}_{_{m,k,1}},G_{I}_{_{m,k,2}}).

In the case of C-SDMA for C²-AT, including two C-BTSs, it can be assumed that the kth AT of the mth BTS estimates a downlink MIMO channel matrix H̅_{m,k,1} from one neighboring interference BTS. A (2n_{T}×1)-sized signal vector X simultaneously transmitted from (2×n_{T}) transmit antennas of the BTS cluster including the mth BTS and the one neighboring interference BTS is received at the kth AT of the mth BTS as a (2n_{T}×1)-sized signal vector Y_{m,k} given by the following equation:

$$\begin{matrix}{Y}_{m , k} = \sqrt{\frac{{γ}_{m , k}}{{n}_{T}}} [ {H}_{m , k} F {α}_{1} {\overline{H}}_{m , k , 1} {G}_{1} ] X + \\ \sqrt{\frac{{γ}_{m , k , 2}}{{n}_{T}}} {\overline{H}}_{m , k , 2} {G}_{2} {i}_{2} + {N}_{m , k} \\ = \sqrt{\frac{{γ}_{m , k}}{{n}_{T}}} {c}_{m , k} ( F , {G}_{1} ) X + \sqrt{\frac{{γ}_{m , k , 2}}{{n}_{T}}} {\overline{H}}_{m , k , 2} {G}_{2} {i}_{2} + {N}_{m , k}\end{matrix} \qquad ( 10 )$$

When compared to Equation (5) for explaining a signal received by C³-AT, Equation (10) shows that the cluster transmission mode (F, G₁) must be determined in such a manner as to maximize multiuser diversity gain at a link from the cluster to the AT. For example, when F={E₁, E₂} is used, the number of cluster transmission modes for C²-AT is expressed by the number of cases where two C-BTSs are selected from among N₀ BTSs belonging to the cluster, multiplied by the number of precoding matrix combinations that may be used for each case, that is, _{N}_{₀}C₂×2^{G}. Also, if N₀=3, then there are a total of 12 cluster transmission modes for C²-AT. The cluster transmission mode providing maximum multiuser diversity gain at each link is determined in the same manner as the above-mentioned scheme for determining the cluster transmission mode for C³-AT.

Therefore, an AT estimates a downlink channel from BTSs belonging to the same cluster, determines the optimal cluster transmission mode according to the number of C-BTSs for which channel estimation is possible, and then transmits the following information to a BTS over the uplink feedback channel:

\textcircled{1} Information on a cluster transmission mode selected by the AT—This information includes information on how many C-BTSs transmit data for the corresponding AT, as well as cluster transmission mode information indicating a combination of precoding matrices to be used by the C-BTSs that are to transmit the data. When the AT feeds back downlink channel estimation information to a base station, the base station may determine how many C-BTSs transmit data and inform the AT of this, and in this case, the AT transmits only a combination of precoding matrices to be used by the C-BTSs.

\textcircled{2} Reception SINR information for n_{T} data streams received at the AT when the C-BTSs transmit them by using the selected cluster transmission mode.

Reference will now be made to cluster scheduling for C-SDMA according to an exemplary embodiment of the present invention.

Each of ATs in the same cluster feeds back a cluster transmission mode selected by each AT and reception SINR information according to the selected cluster transmission mode to a BTS to which each AT belongs. Each of BTSs in the same cluster delivers information, fed back from ATs belonging to each BTS, to a cluster scheduler over a wireline communication network. ATs belonging to the same cluster may be classified into an AT operating in non-collaborative technology (NC-AT), an AT desiring collaborative transmission between two C-BTSs (C²-AT), and an AT desiring collaborative transmission between three C-BTSs (C³-AT), according to the environment in which each AT is located. The cluster scheduler collects the cluster transmission modes selected by the ATs in the cluster and the SINR information according to the selected cluster transmission modes, selects a cluster transmission mode to be used by the cluster (i.e. a combination of precoding matrices to be used by the C-BTSs), which maximizes a scheduling criterion, by using the collected cluster transmission modes and SINR information, and selects ATs, to which data is transmitted through the selected cluster transmission mode, from among all the ATs belonging to the cluster.

Supposing that the number of precoding matrices in a precoder codebook is G, and the number of BTSs included in the cluster is N_{T}, the number of transmission modes that can be used by the cluster is Σₗ₌₁^{N}^{_{T}}_{N}_{_{T}}Cₗ×G^{l}. Here, l denotes the number of C-BTSs that simultaneously transmit data for one AT, the number of transmission modes for l C-BTSs, _{N}_{_{T}} Cₗ×G^{l}, corresponds to the number of cases where l C-BTSs are selected from among the N_{T} BTSs belonging to the cluster, multiplied by the number of precoding matrix combinations that can be used for each case. Σₗ₌₁^{N}^{_{T}}_{N}_{_{T}}Cₗ×G^{l} includes all possible cluster transmission modes from a cluster transmission mode for NC-AT using one C-BTS to a cluster transmission mode for C^{N}^{_{T}}-AT using N_{T} C-BTSs. If N_{T}=3 and G=2 are assumed, then a total of 26 cluster transmission modes are possible, and thus 5 bits are required to express one cluster transmission mode selected by an AT.

The cluster scheduler groups all the ATs belonging to the cluster into AT groups according to cluster transmission modes selected by the respective ATs. ATs belonging to the same AT group can share a cluster transmission mode. That is, for ATs that have selected the same cluster transmission mode, C-BTSs can transmit data by using precoding matrices of the corresponding cluster transmission mode. Also, according to the precoding matrix used by a C-BTS, a cluster transmission mode for C³-AT may be used with a cluster transmission mode that each BTS can use for NC-AT transmission or a cluster transmission mode for C²-AT.

Table 1 as presented below illustrates a compatibility relation between a cluster transmission mode for NC-AT, a cluster transmission mode for C²-AT, and a cluster transmission mode for C³-AT. Here, it is assumed that G is equal to 2, and X denotes a precoding matrix used by NC-BTS. In particular, X suggests that any precoding matrix belonging to a precoder codebook may be used as X. Each cluster transmission mode for C³-AT, included in the third row of Table 1, is compatible with the right upper cluster transmission mode for C²-AT, and each cluster transmission mode for C²-AT, included in the second row of Table 1, is compatible with the right upper cluster transmission mode for NC-AT. Thus, any cluster transmission mode for C²-AT and any cluster transmission mode for C³-AT may be used at the same time with the upper cluster transmission mode for NC-AT, included in the row of Table 1.

TABLE 1

| NC-AT | (E₁, X, X) | | | | (E₂, X, X) | | | |
|---|---|---|---|---|---|---|---|---|
| C²-AT | (E₁, E₁, X) | | (E₁, E₂, X) | | (E₂, E₁, X) | | (E₂, E₂, X) | |
| C³-AT | (E₁, E₁, | (E₁, E₁, | (E₁, E₂, | (E₁, E₂, | (E₂, E₁, | (E₂, E₁, | (E₂, E₂, | (E₂, E₂, |
| | E₁) | E₂) | E₁) | E₂) | E₁) | E₂) | E₁) | E₂) |

The cluster scheduler performs scheduling for all of NC-AT, C²-AT, and C³-AT. The cluster scheduler groups all the ATs belonging to the cluster into eight AT groups based on the cluster transmission modes for C³-AT, according to cluster transmission modes selected by the respective ATs. NC-ATs and C²-ATs also belong to an AT group using a cluster transmission mode for C³-AT that is compatible with the cluster transmission mode selected by each AT. That is, since the cluster transmission mode (E₁, X, X) in the first row of Table 1 is compatible with the four lower cluster transmission modes for C³-AT, in the third row of Table 1, it is overlappingly included in the corresponding four AT groups. In a similar manner, since the cluster transmission mode for C²-AT, E₁,E₁,X), is compatible with the lower cluster transmission modes for C³-AT, (Eₗ,E₁,E₁) and (Eₗ,E₁,E₂), it is overlappingly included in the corresponding two AT groups.

Let {S_{g}}_{g=1, . . . , S} be eight AT groups according to cluster transmission modes. Then, scheduling is performed for each AT group {S_{g}}_{g=1, . . . , S}. ATs with highest scheduling priority, to which data is to be transmitted, are selected using (3×n_{T}) transmission weights of a cluster transmission mode used by each AT group. A BTS selects the z_{g,n}^{*}th AT, to which data is to be transmitted, by using the nth transmission weight of the gth transmission mode, as given in the following equation:

$${z}_{g , n}^{*} = arg {max}_{z = 1 , … , {K}_{g} , z ∈ {S}_{g}} priority ( {\tilde{ρ}}_{z , n} ) \qquad ( 11 )$$

Here, priority(\tilde{ρ}_{z,n}) denotes scheduling priority obtained using the SINR \tilde{ρ}_{z,n} that the zth AT belonging to the gth AT group S_{g} can receive through the nth transmission weight of the gth cluster transmission mode. \tilde{ρ}_{z,n} is information fed back to the cluster scheduler via the BTS to which the zth AT belongs. For example, a max throughout scheduler sets priority(\tilde{ρ}_{z,n}) to priority(\tilde{ρ}_{z,n})=log₂(1+\tilde{ρ}_{z,n}). In conclusion, for ATs using the same cluster transmission mode, the cluster scheduler selects an AT maximizing scheduling priority according to transmission weights of the corresponding cluster transmission mode. Thus, ATs to which data is to be transmitted are selected for each AT group through (3×n_{T}) transmission weights, and scheduling priority pri_{g} for each group, represented by the ATs selected in this way, is determined by Equation (12). Although scheduling priority of a corresponding AT group is described as a summation of scheduling priority of selected ATs in this embodiment of the present invention, other schemes may be used as a way to obtain scheduling priority for each AT group.

$${pri}_{g} = {\sum }_{n = 1}^{3 {n}_{T}} priority ( {\tilde{ρ}}_{{z}_{g , n}^{*} , n} ) \qquad ( 12 )$$

The cluster scheduler selects an AT group with the highest group scheduling priority by using scheduling priority for each AT group, as given in the following equation:

$${S}_{{g}^{*}} = arg {max}_{{S}_{g} , g = 1 , … , G} {pri}_{g} \qquad ( 13 )$$

Thus, an AT group S_{g*}, to which data is to be transmitted, and a cluster transmission mode to be used by the corresponding group, that is, precoding matrices to be used by BTSs belonging to the cluster, are determined. Also, the cluster scheduler may determine the MCS of the data to be transmitted, by using the reception SINR of ATs to which the data is to be transmitted.

The cluster scheduler determines ATs {z_{g*,n}}_{n=1, . . . , S}_{_{nT}} to which the data is to be transmitted, and delivers information on the determined ATs, that is, information on the cluster transmission mode to be used by the corresponding ATs and information on the MCS of the data to be transmitted, to each BTS over the wireline communication network. For the selected ATs {z_{g*,n}}_{n=1, . . . , S}_{_{nT}}, each BTS creates data streams of the corresponding MCS level, precodes the created data streams in the selected cluster transmission mode, and then transmits the precoded data streams through transmit antennas of C-BTSs in the cluster.

ATs using cluster transmission modes for NC-AT and C²-AT, compatible with the selected cluster transmission mode, may be included in the ATs determined by the cluster scheduler, to which the data is to be transmitted. For NC-ATs and C²-ATs selected as a transmission target of the data, data streams of the corresponding MCS level are also created, precoded in the NC-AT or C²-AT cluster transmission mode to be used, and transmitted through the transmit antennas of the corresponding BTSs.

Reference will now be made to selection of an extended cluster transmission mode for increasing multiuser diversity gain and feedback information corresponding thereto.

In C-SDMA technology according to the above embodiments of the present invention, scheduling is performed for ATs selecting the same cluster transmission mode or cluster transmission modes compatible with each other. Thus, the number of precoding matrix combinations transmittable by C-BTSs, that is, the number of cluster transmission modes, increases with an increase in the number of precoding matrices in a precoder codebook, G, and the number of C-BTSs belonging to the cluster. An increase in the number of cluster transmission modes reduces the number of ATs selecting the same cluster transmission mode. More specially, the number of cluster transmission modes is 8 when the number of C-BTSs is 3 and G=2, and is 1 when the number of C-BTSs is 3 and G=1. When the number of cluster transmission modes is 8, ATs are grouped into eight AT groups, and scheduling is performed for each of the eight AT groups. Contrarily, when the number of cluster transmission modes is 1, scheduling is performed for all ATs because all the ATs belong to one group. That is, if the number of cluster transmission modes increases, then the number of ATs for which multiuser scheduling is performed decreases, and thus multiuser diversity gain at the system level is reduced. However, if the size of a precoder codebook, that is, G, increases, then minute precoding is possible at each link, and thus the reception SINR of each link increases. Therefore, there is a need for a way to increase gain at each link by increasing the size of a precoder codebook and at the same time overcome a decrease in multiuser diversity gain due to an increase in the size of the codebook.

To this end, according to an exemplary embodiment of the present invention, a scheme is proposed, in which an AT selects G cluster transmission modes, and feeds back them to a BTS. This increases feedback information amount by G times, as compared to the above-mentioned single transmission mode selection mode. An AT selects a cluster transmission mode that maximizes multiuser diversity gain at the link from the C-BTS cluster to the kth AT of the mth BTS when a BTS to which the AT belongs uses each of G precoding matrices in a codebook. More specially, when a code book F={Eₗ, E₂} is used, the number of C-BTSs is 3, and a BTS to which an AT belongs uses a precoding matrix Eₘ, precoding matrices G_{m,1} and G_{m,2} to be used by other C-BTSs are determined by the following equation:

$$( {G}_{m , 1} , {G}_{m , 2} ) = arg {max}_{( {G}_{a} , {G}_{b} ) , {G}_{a} , {G}_{b} ∈ F} {max}_{n = 1 , … , {n}_{T}} {ρ}_{m , k , n} ( {E}_{m} , {G}_{a} , {G}_{b} ) \qquad ( 14 )$$

According to Equation (14), for four cluster transmission modes using the precoding matrix Eₘ of the BTS among a total of eight cluster transmission modes, the kth AT selects the cluster transmission modes that maximize the SINR of a data stream having the highest SINR from among n_{T} received data streams. Thus, the kth AT informs the mth BTS over an uplink feedback channel of the indexes indicating the selected cluster transmission modes (E₁, G_{1,1}, G_{1,2}) and (E₂, G_{2,1}, G_{2,2}), and the SINRs {ρ_{m,k,n}(E₁G_{1,1}, G_{1,2})}_{n=1, . . . , n}_{_{T}} and {ρ_{m,k,n}(E₂, G_{2,1}G_{2,3})}_{n=1, . . . , n}_{_{T}} for the n_{T} data streams received at the AT when the mth BTS transmits data by using the corresponding cluster transmission modes. In summary, an AT transmits the following information to a BTS over an uplink feedback channel:

\textcircled{1} Information indicating the AT feeds back G cluster transmission modes.

\textcircled{2} Information on cluster transmission modes selected by the AT—This information includes information on how many C-BTSs transmit data for the corresponding AT, as well as cluster transmission mode information indicating combinations of precoding matrices to be used by the C-BTSs that are to transmit the data together.

\textcircled{3} Reception SINR information for n_{T} data streams received at the AT in each of the G cluster transmission modes to be used by the C-BTSs.

In the extended cluster transmission mode selection and feedback scheme, proposed in this embodiment of the present invention, respective ATs deliver G cluster transmission modes and reception SINR information according thereto to the cluster scheduler, and thereby are included in AT groups according to the G cluster transmission modes. Thus, since the number of ATs included in AT groups according to the respective cluster transmission modes increases, it is possible to increase multiuser diversity gain. However, the feedback scheme according to the extended cluster transmission mode selection requires feedback information amount that is G times as large as that required in the single cluster transmission mode selection scheme.

Reference will now be made to a method of selecting the optimal cluster transmission mode for all C-BTSs and a feedback scheme therefor.

As another way to overcome a decrease in multiuser diversity gain due to an increase in the size of a codebook, the present invention proposes a scheme in which each AT selects one optimal cluster transmission mode for each C-BTS, and feeds back information thereon to each C-BTS. This optimal cluster transmission mode selection and feedback scheme is different from the extended cluster transmission mode selection and feedback scheme in that an AT selects and feeds back G cluster transmission modes for one BTS to which the AT belongs in the extended cluster transmission mode selection and feedback scheme, but an AT selects one optimal cluster transmission mode for each of all C-BTSs and feeds back it to each C-BTS in the optimal cluster transmission mode selection and feedback scheme to be described below.

The cluster transmission mode that maximizes multiuser diversity gain at the link between the mth C-BTS among M C-BTSs and the kth AT is determined by Equation (9). As described in Equation (9), the cluster transmission mode that maximizes the SINR of a stream having the highest SINR from among n_{T} streams transmitted by the mth BTS and received by the kth AT is selected. The cluster transmission mode selected in this way is the optimal precoding matrix combination that maximizes channel gain from the mth BTS to the kth AT, and at the same time, minimizes interference from two neighboring C-BTSs.

In the scheme in which the optimal cluster transmission mode for each of all C-BTSs is selected and fed back according to this embodiment of the present invention, the optimal cluster transmission mode from one AT to each C-BTS is selected for all M C-BTSs. That is, for the M C-BTSs, each AT selects the optimal cluster transmission mode to the mth C-BTS. For the M C-BTSs, the kth AT informs the mth BTS over an uplink feedback channel of the index indicating the optimal cluster transmission mode to the mth C-BTS, and the SINR {ρ_{m,k,n}(F_{m,k},G_{I}_{_{m,k,1}},G_{I}_{_{m,k,2}})}_{n=1, . . . , n}_{_{T}} for n_{T} data streams received at the kth AT when the mth C-BTS transmits data by using the corresponding cluster transmission mode. Each C-BTS delivers such feedback information to the cluster scheduler over a wireline communication network. That is, an AT transmits the following information to each C-BTS over an uplink feedback channel:

\textcircled{1} Information indicating the AT feeds back one cluster transmission mode for each of all M C-BTSs.

\textcircled{2} Information on the optimal cluster transmission mode to each C-BTS, selected by the AT—This information includes optimal cluster transmission mode information to be used when each C-BTS transmits data to the corresponding AT.

\textcircled{3} SINR information for data streams received at the AT when each C-BTS transmits data to the corresponding AT by using the optimal cluster transmission mode.

In the scheme in which the optimal cluster transmission mode for each of all C-BTSs is selected and fed back according to this embodiment of the present invention, the optimal cluster transmission mode is selected for all the C-BTSs including a BTS to which an AT belongs, and is fed back to the cluster scheduler. Thus, the cluster scheduler receives a total of M pieces of optimal cluster transmission mode information fed back from one AT via M C-BTSs. Since channels from one AT to the M C-BTSs are independent of each other, one AT is scheduled just like different M ATs, and thereby multiuser diversity gain can be increased. Contrarily, the optimal cluster transmission mode selection and feedback scheme according to this embodiment requires feedback information amount that is M times as large as that required in the scheme in which a single cluster transmission mode to one BTS to which an AT belongs is selected.

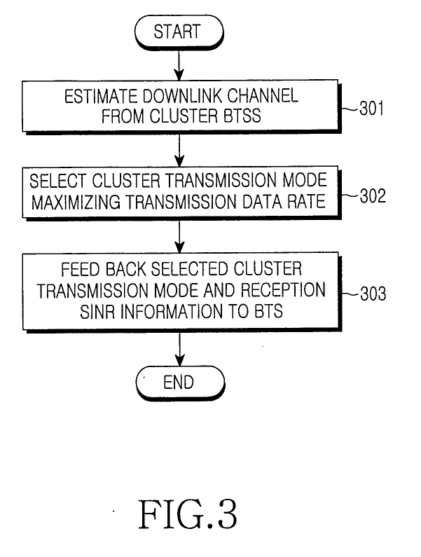

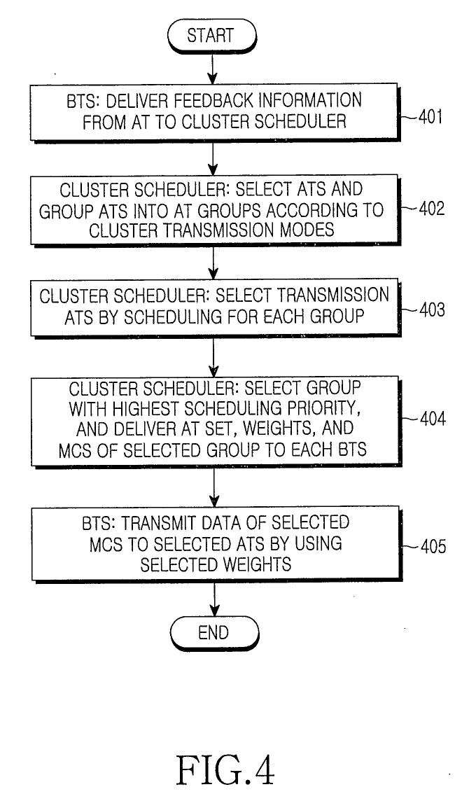

FIG. 3 illustrates an operation procedure of an access terminal in C-SDMA technology according to an exemplary embodiment of the present invention, and FIG. 4 illustrates an operation procedure of a base station in C-SDMA technology according to an exemplary embodiment of the present invention.

Referring to FIG. 3, in step 301, each AT estimates a downlink MIMO channel from BTSs belonging to the cluster. In step 302, each AT determines the cluster transmission mode that maximizes multiuser diversity gain at each AT link, and the SINR receivable at the AT when the corresponding cluster transmission mode is used, based on the downlink channel estimated from the BTSs belonging to the cluster. Each AT selects only one cluster transmission mode when the single cluster transmission mode selection and feedback scheme is used, and selects G cluster transmission modes when the extended cluster transmission mode selection and feedback scheme is used. Also, when the optimal cluster transmission mode selection and feedback scheme is sued, each AT selects the optimal cluster transmission mode for each of all C-BTSs. In step 303, each AT feeds back information on a feedback mode to be used by each AT (information indicating selection of the single cluster transmission mode or the extended cluster transmission mode or the optimal cluster transmission mode), information on the selected cluster transmission mode (this information includes the number of C-BTSs simultaneously transmitting data, and the corresponding cluster transmission mode), and reception SINR information of the AT according to the selected cluster transmission mode to a BTS, to which the corresponding AT belongs, over an uplink feedback channel. Also, when the optimal cluster transmission mode is selected for all C-BTSs, each AT feeds back the above information to each C-BTS.

Referring to FIG. 4, in step 401, each BTS delivers information, fed back from respective ATs, to the cluster scheduler connected thereto over a wireline communication network.

In step 402, the cluster scheduler groups ATs into AT groups including ATs that select the same cluster transmission mode or cluster transmission modes compatible with each other. In step 403, the cluster scheduler performs scheduling for each AT group. Through this scheduling for each AT group, (N_{T}×n_{T}) ATs to which data is to be transmitted using the corresponding cluster transmission mode are selected for each group, and the representative scheduling priority of each group is determined. In step 404, the cluster scheduler selects the AT group maximizing group scheduling priority, and thereby determines (N_{T}×n_{T}) ATs to which data is to be transmitted from the cluster, the cluster transmission mode to be used by the corresponding ATs, and the MCS of data to be transmitted using the corresponding cluster transmission mode. Also, the cluster scheduler delivers the determined information to each BTS in the cluster over the wireline communication network.

Finally, in step 405, BTSs in the cluster create data streams of the corresponding MCS level, precode the created data streams with the selected cluster transmission mode, and simultaneously transmit the data streams to ATs belonging to the corresponding BTS through C-BTSs.

Reference will now be made to collaborative beamforming technology.

In C-SDMA technology as described above, data is simultaneously transmitted from multiple BTSs belonging to the same cluster to multiple ATs belonging to the same cluster. C-SDMA technology according to an exemplary embodiment of the present invention can operate in collaborative beamforming (C-BF) technology, in which each BS transmits data to one AT, by minimizing inter-cell interference due to BF of neighboring BTSs through C-BF of multiple BTSs belonging to the same cluster.

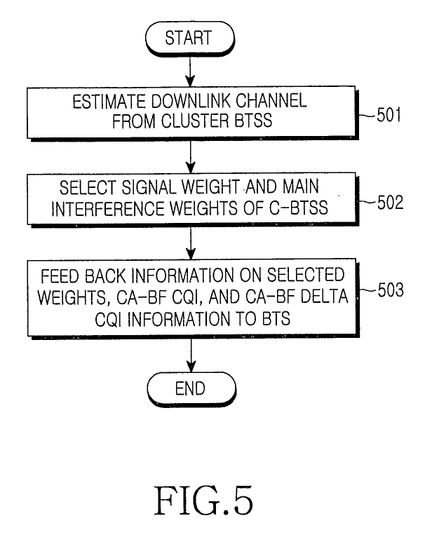

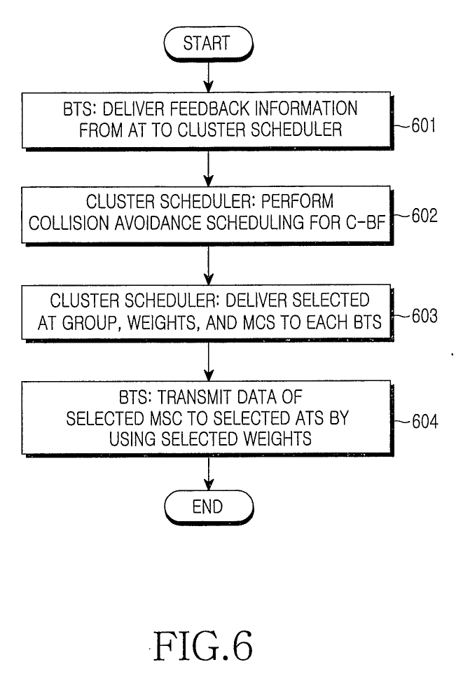

FIG. 5 illustrates an operation procedure of an access terminal in C-BF according to an exemplary embodiment of the present invention, and FIG. 6 illustrates an operation procedure of a base station in C-BF according to an exemplary embodiment of the present invention.

In this embodiment of the present invention, C-BF for C³-AT, including three C-BTSs, will be described. First, in step 501, the kth AT of the mth BTS estimates a downlink MIMO channel matrix { H̅_{m,k,i}}_{i=1,2} from two neighboring interference BTSs. A (3*1)-sized signal vector X_{BF} simultaneously transmitted from 3n_{T} transmit antennas of the BTS cluster including the mth BTS and the two neighboring BTSs is received at the kth AT of the mth BTS as a signal vector Y_{m,k} given by the following equation:

$$\begin{matrix}{Y}_{m , k} = \sqrt{\frac{{γ}_{m , k}}{{n}_{T}}} [ {H}_{m , k} f {α}_{1} {\overline{H}}_{m , k , 1} {g}_{1} {α}_{2} {\overline{H}}_{m , k , 2} {g}_{2} ] {X}_{BF} + {N}_{m , k} \\ = \sqrt{\frac{{γ}_{m , k}}{{n}_{T}}} {c}_{m , k} ( f , {g}_{1} , {g}_{2} ) {X}_{BF} + {N}_{m , k}\end{matrix} \qquad ( 15 )$$

Here, Y_{m,k} denotes an (n_{R}*1)-sized reception signal vector, N_{m,k} denotes an (n_{R}*1)-sized noise vector, and C_{m,k}(f, g₁, g₂)=[H_{m,k}f α₁ H̅_{m,k,1}g₁ α₂ H̅_{m,k,2}g₂] denotes an (n_{R}*3)-sized downlink channel matrix received at the kth AT of the mth BTS when three C-BTSs belonging to the C-BTS cluster perform BF by using weights f, g₁, and g₂ respectively. According to Equation (15), the weight vector f to be used by the mth BTS and the weight vector {gᵢ}_{i=1,2} to be used by each of the two interference BTSs, which maximize the SINR at the link from the C-BTS cluster to the kth AT of the mth BTS, must be determined at the same time. In this way, the weights to be used the respective BTSs is determined in such a manner as to maximize the reception SINR, which makes it possible to determine the optimal weight combination that increases gain by BF, and simultaneously minimizes inter-cell interference due to BF of the neighboring BTSs. However, when a precoder codebook consisting of G precoding matrices, and the number of C-BTSs is l, the number of transmission modes for C-BF is (Gₙ_{_{T}})^{l}, which corresponds to a considerably large value. Thus, many feedback bits are required to feedback the selected cluster transmission mode. Also, when the cluster scheduler groups ATs into AT groups, each of which includes ATs selecting the same cluster transmission mode, and performs scheduling for the AT groups, transmission capacity decreases as multiuser diversity gain decreases due to the scheduling.

Therefore, in this embodiment of the present invention, when the cluster transmission mode is selected, each AT selects the signal weight vector f that maximizes gain from the mth BTS to the kth AT, that is, that the AT desires the BTS to transmit, and the main interference weight vector {dᵢ}_{i=1,2} that maximizes the amount of interference from each interference BTS to the AT, that is, that the AT does not desire each interference BTS to use, and feeds back them to the BTS to which the AT belongs. Using the signal weight vector information and the main interference weight vector information fed back from each AT, the cluster scheduler performs scheduling in such a manner that the AT to which data is to be transmitted uses the signal weight vector for the corresponding AT, but each interference C-BTS does not use the main interference weight vector for the corresponding AT. When the number of weight vectors used by a base station is 2 or more, it is also possible to group a plurality of weights into weight groups and feed back a main interference weight group in order to reduce the number of feedback bits.

Supposing that a precoder codebook F={E₁, E₂} consisting of two precoding matrices is used, in step 502 of FIG. 5, the signal weight vector f and the main interference weight vector {dᵢ}_{i=1,2} for the kth C3-AT of the mth BTS are obtained by the following equation:

$$f = arg {max}_{{e}_{1} ∈ F} {‖ {H}_{m , k} {e}_{1} ‖}^{2} \\ {d}_{1} = arg {max}_{{e}_{2} ∈ F} {‖ {\overline{H}}_{m , k , 1} {e}_{2} ‖}^{2} \\ {d}_{2} = arg {max}_{{e}_{3} ∈ F} {‖ {\overline{H}}_{m , k , 2} {e}_{3} ‖}^{2} . \qquad ( 16 )$$

Here, {eₘ}_{m=1,2,3} denotes column vectors of the precoding matrices in the precoder codebook F. That is, Equation (16) shows that, from among Gn_{T} column vectors belonging to F, column vectors maximizing channel gain from the BTS to which the AT belongs and the two interference BTSs to the AT are selected as the signal weight vector f and the main interference weight vector {dᵢ}_{i=1,2} respectively.

If the precoder codebook F is so designed that the Gn_{T} column vectors indicate uniformly divided azimuths, then channel gain received at an AT by weights indicating adjacent azimuths becomes similar as the number of transmit antennas or precoding matrices belonging to the codebook increases. Thus, weights indicating adjacent azimuths, as well as the selected main interference weight vector {dᵢ}_{i=1,2}, may also considerably interfere with the corresponding AT. In such a case, when the cluster scheduler performs scheduling, it considers the main interference weight vector {dᵢ}_{i=1,2} and even the weights indicating adjacent azimuths as the main interference weight vector, and calculates collision between beams formed by weights that each C-BTS uses. For example, when G=2 and n_{T}=4, the main signal weight vector f and two weight vectors indicating adjacent azimuths are considered a main signal weight vector set D, the main interference weight vector {dᵢ}_{i=1,2} and two adjacent weight vectors are considered a main interference weight vector set {Lᵢ}_{i=1,2}, and collision between beams formed by weights that each C-BTS uses is calculated.

The AT calculates the SINR that is received at the AT when the mth BTS uses the signal weight vector f and each interference C-BTS does not use weight vectors belonging to the main interference weight vector set Lᵢ. In order to calculate the SINR received at the AT, the AT averages interference quantities received from weight vectors that do not belong to the main interference weight vector set Lᵢ from among the Gn_{T} weights belonging to F, and thereby obtains the average interference quantity received at the AT from each C-BTS. The reception SINR at the AT, obtained in this way, is the SINR received when collision between beams formed by weights that each C-BTS uses is avoided by the cluster scheduling, and this SINR is referred to as “CA (Collision Avoidance)-BF CQI”.

However, if the number of C-ATs is small, there may occur a case where collision between beams formed by weights that each C-BTS uses is not avoided. To handle this case, the AT calculates the SINR received at the AT when the mth BTS uses the signal weight vector f and each interference C-BTS uses weight vectors belonging to the main interference weight vector set Lᵢ. In order to calculate the SINR received at the AT, the AT averages interference quantities received from weight vectors belonging to the main interference weight vector set Lᵢ, and thereby obtains the average interference quantity received at the AT from each C-BTS. The reception SINR at the AT, obtained in this way, is the SINR received when collision between beams formed by weights that each C-BTS uses is not avoided by the cluster scheduling. The AT subtracts this reception SINR from the CA-BF CQI, and the resultant value is referred to as “CA-BF delta CQI”. The AT feeds back the CA-BF delta CQI, together with the following information, to the BTS (step 503). That is, using feedback information on the CA-BF CQI and the CA-BF delta CQI, the cluster scheduler can know the SINR values received at the AT when collision between beams is avoided and is not avoided, respectively.

\textcircled{1} Information on signal weight vector f and main interference weight vector {dᵢ}_{i=1,2} selected by the AT—Instead of the main interference weight vector, a weight vector providing minimum interference may be transmitted as this information, or a main interference weight vector group may be fed back as this information by grouping weight vectors into weight groups. Feeding back the weight vector group is intended to reduce feedback overhead.

\textcircled{2} Reception SINR information for a single data stream received by the AT when the BTS to which the AT belongs uses the selected signal weight vector f and two interference C-BTSs do not use the main interference weight vector {dᵢ}_{i=1,2}-CQI obtained when collision between beams does not occur, that is, CA-BF CQI, and a difference between the CA-BF CQI and CQI obtained when collision occurs, that is, CA-BF delta CQI, may be transmitted as this information, or CA-BF CQI corresponding to CQI obtained when collision between beams occurs and CA-BF delta CQI obtained by subtracting CQI for no collision from the CA-BF-CQI may be transmitted as this information.

Referring to FIG. 6, in step 601, a BTS delivers feedback information, received from ATs, to the cluster scheduler. In step 602, the cluster scheduler calculates transmittable data capacity for all C-AT combinations, and determines a C-AT combination with the highest scheduling priority and BF weights to be used by the corresponding combination. For example, supposing that there are two C-BTSs, each including two C-ATs, a total of two C-AT combinations exist. Using signal weight vector information and main interference weight vector information fed back by each AT, the cluster scheduler determines if weights belonging to the signal weight vector set of one AT of each C-AT combination coincide with weights belonging to the main interference weight vector of the other AT. When they do not coincide with each other, the cluster scheduler calculates system transmission capacity by using CA-BF CQI information because “collision avoidance BF” for avoiding collision between beams is possible. Contrarily, when they coincide with each other, collision avoidance BF is impossible. Thus, the cluster scheduler subtracts CA-BF delta CQI from the CA-BF CQI to obtain the reception SINR received when collision between beams is not avoided, and uses the obtained reception SINR to calculate system transmission capacity. Using the calculated system transmission capacity, the cluster scheduler selects a C-AT combination with higher priority from among a total of two C-AT combinations. In fact, since a C-AT combination capable of collision avoidance provides high system transmission capacity, inter-cell interference can be suppressed and transmission data capacity can be improved by avoiding collision between beams formed by weights that each BTS uses through collision avoidance BF scheduling.

In step 603, the cluster scheduler transmits information on one AT to which each BTS transmits data, a BF weight to be used by the corresponding AT, and the MCS of data to be transmitted using the corresponding BF weight to each BTS. In step 604, the corresponding BTS transmits data to the AT according to the information delivered from the cluster scheduler.

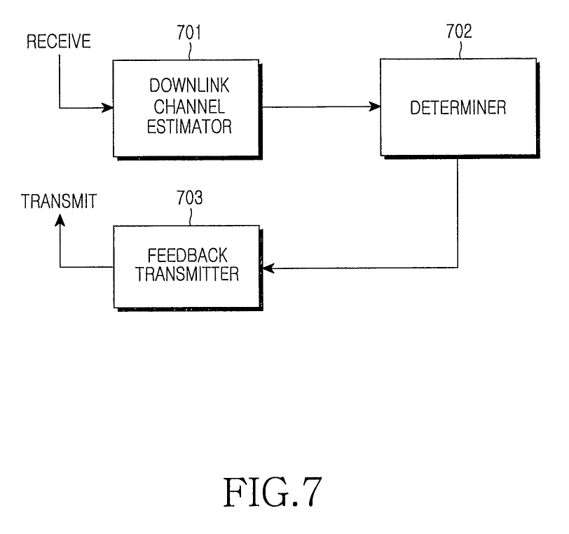

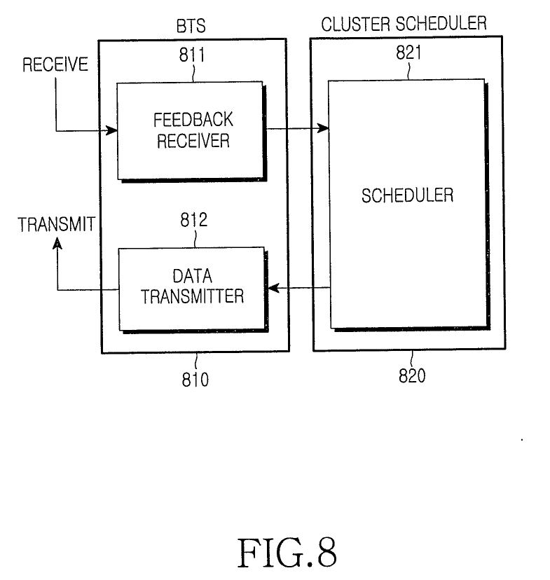

FIG. 7 illustrates an AT for performing C-SDMA or BF according to an exemplary embodiment of the present invention, and FIG. 8 illustrates a BTS for performing C-SDMA or BF according to an exemplary embodiment of the present invention.

Referring to FIG. 7, the AT includes a downlink channel estimator 701, a determiner 70-2, and a feedback transmitter 703. The downlink channel estimator 701 estimates a downlink channel by using a downlink sounding reference signal received from a BTS. The determiner 702 selects transmission modes and SINRs, precoding matrices, or signal weights according to a result of estimation by the downlink channel estimator 701. The feedback transmitter 703 transmits information determined by the determiner 702 to a BTS over an uplink feedback channel.

Referring to FIG. 8, the base station system includes a BTS 810 and a cluster scheduler 820, the BTS 810 includes a feedback receiver 811 and a data transmitter 812, and the cluster scheduler 820 includes a scheduler 821.

The feedback receiver 811 receives feedback information from an AT over an uplink feedback channel, and the scheduler 821 determines ATs to which to transmit data and the MCS of data, precoding matrices, or weights by using the feedback information received by the feedback receiver 811. The data transmitter 812 applies the corresponding MCS and precoding matrices or weights for the corresponding AT, and transmits data to the AT.

C-SDMA technology for effectively suppressing inter-cell interference from neighboring BTSs, based on existing SDMA technology using a precoder codebook, in an FDD system has been described above. In order to analyze the performance of C-SDMA technology according to the present invention, the performance of C-SDMA technology proposed in the present invention will be compared with the performance of NC-SDMA technology, that is, the existing SDMA technology using a precoder codebook in which scheduling is performed for each BTS, on a system level capacity basis in one cluster including three C-BTSs.

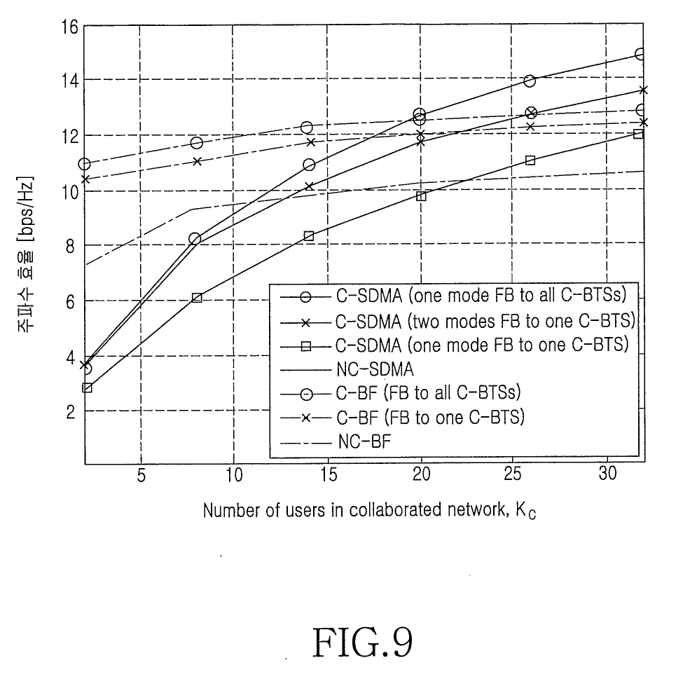

FIG. 9 illustrates a comparison between NC-SDMA technology and C-SDMA technology in one cluster including K_{G} C³-ATs capable of estimating a downlink channel from three C-BTSs, which is made based on capacity in the cluster and according to the number of precoding matrices in a precoder codebook, G, and the number of cluster transmission modes fed back from each AT. It is assumed that the number of transmit antennas of each BTS, n_{T}, is 4, an interval between transmit antennas is 0.5λ, the number of receive antennas of each AT, n_{R}, is 4, an interval between receive antennas is 0.5λ, and all the K_{G} C-ATs receives a signal with an average SNR of 10 dB from each of the three C-BTSs.

An MIMO channel coefficient was generated 10000 times at each link from the cluster to each of the K_{G} C-ATs to obtain cluster capacity, and the obtained cluster capacity was averaged. The average cluster capacity obtained in this way was used as a yardstick for performance. When the channel coefficient was generated, AOD (Angle of Departure) at the transmitting end of the BTS and AOA (Angle of Arrival) at the receiving end of the AT were uniformly formed within (−30, 30). When the channel was generated at each link, an MIMO channel with spatial correlation was generated using Equation (17) as given below, and the spatial correlation matrix at the transmitting end of the BTS, R_{T}, and the spatial correlation matrix at the receiving end of the AT, R_{R}, were obtained using a linear antenna array and a model where an angular spectrum was uniformly distributed over Δ_{T} and Δ_{R} with respect to the AOD and AOA respectively. The downlink channel matrix of the kth C-AT is given by the following equation:

Hₖ=R_{R}^{1/2}H_{w}R_{T}^{1/2} (17)

Here, Hw denotes an (n_{T}*n_{R})-sized complex Gaussian matrix with no correlation. Δ_{T}=5° and Δ_{R}=60° are assumed for all the K_{G} links.

Precoding matrices used in FIG. 9 are given by the following equation; F={E₁} when G=1, and F={E₁, E₂} when G=2:

$${E}_{1} = \frac{1}{2} [ \begin{matrix}1 & 1 & 1 & 1 \\ 1 & {e}^{s π / 2} & {e}^{s π} & {e}^{s 3 π / 2} \\ 1 & {e}^{s π} & {e}^{s 2 π} & {e}^{s 3 π} \\ 1 & {e}^{s 3 π / 2} & {e}^{s 3 π} & {e}^{s 8 π / 2}\end{matrix} ] , \\ {E}_{2} = \frac{1}{2} [ \begin{matrix}1 & 1 & 1 & 1 \\ {e}^{s π / 4} & {e}^{s 3 π / 4} & {e}^{s 5 π / 4} & {e}^{s 7 π / 4} \\ {e}^{s π / 2} & {e}^{s 3 π / 2} & {e}^{s 5 π / 2} & {e}^{s 7 π / 2} \\ {e}^{s 3 π / 4} & {e}^{s 8 π / 4} & {e}^{s 15 π / 4} & {e}^{s 21 π / 4}\end{matrix} ] \qquad ( 18 )$$

In FIG. 8, it can be noted that C-SDMA technology exhibits higher cluster capacity than that of NC-SDMA technology. Thus, it can be confirmed that C-SDMA technology effectively suppresses inter-cell interference, and improves system capacity. Also, C-SDMA technology provides higher cluster capacity when G=2, as compared when G=1. This is because minute precoding is possible for each link and thus the reception SINR at each link increases as the size of a used precoder codebook increases.

Referring to FIG. 9, in the case of C-SDMA, it can be noted that the scheme to select and feed back G cluster transmission modes and the scheme to select one cluster transmission mode and feed back it to all C-BTSs provide considerably higher capacity than that of the single cluster transmission mode selection and feedback scheme. In particular, it can be noted that the scheme to select one cluster transmission mode and feed back it to all C-BTSs provides higher capacity than that of the scheme to select and feed back G cluster transmission modes while using the same amount of feedback information. Also, in the case of C-BF, it can be noted that the scheme to perform collision avoidance BF to all C-BTSs provides significantly higher capacity than that of the scheme to perform collision avoidance BF to one BTS to which an AT belongs.

Comparing performances of C-SDMA technology and C-BF technology, the smaller the number of C-ATs and interference quantities from interference BTSs, the higher capacity provided by C-BF is. Contrarily, the larger the number of C-ATs and interference quantities from interference BTSs, the higher capacity provided by C-SDMA is. Thus, high capacity can be implemented by adaptively selecting technology providing higher system capacity from among C-SDMA and C-BF, depending on the number of C-ATs and channel environment from interference BTSs.

Therefore, according to another embodiment of the present invention, there is proposed a hybrid C-SDMA/C-BF scheme and a feedback scheme therefor, in which technology providing higher system capacity is adaptively selected from among C-SDMA and C-BF, depending on the number of C-ATs and interference environment.

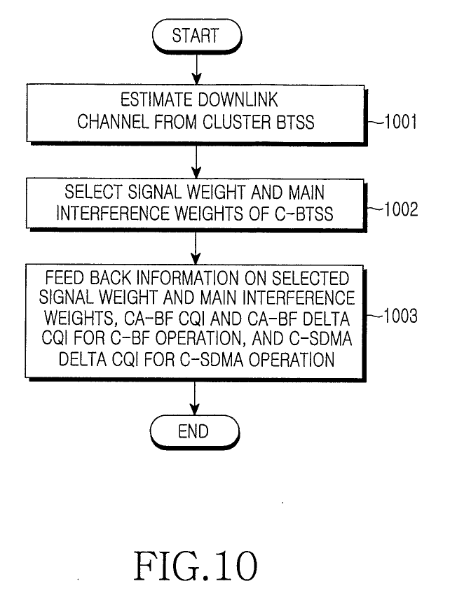

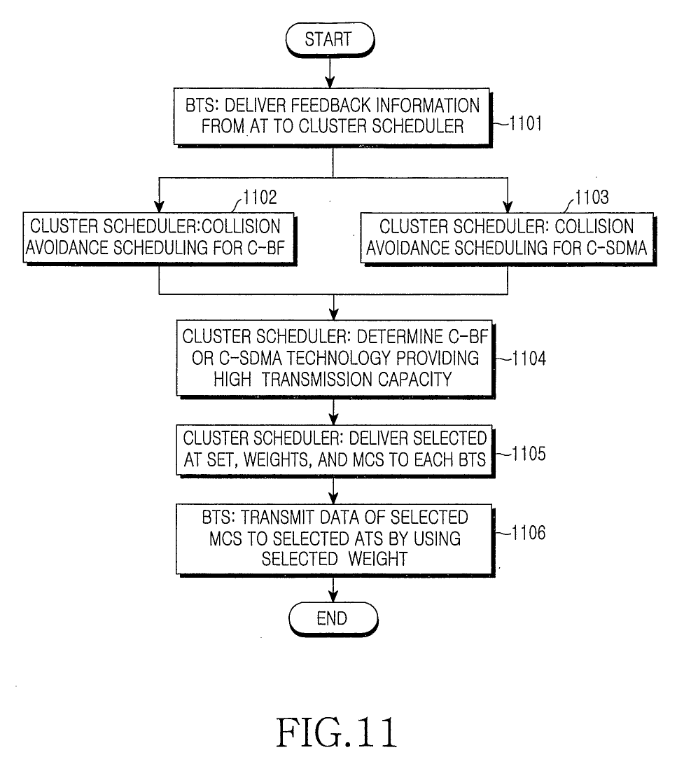

FIG. 10 illustrates an operation procedure of an access terminal in hybrid C-SDMA/C-BF technology according to an exemplary embodiment of the present invention, and FIG. 11 illustrates an operation procedure of a base station in hybrid C-SDMA/C-BF technology according to an exemplary embodiment of the present invention.

Referring to FIG. 10, in step 1001, each AT estimates a downlink MIMO channel from BTSs belonging to the cluster. Based on the downlink MIMO channel estimated from the BTSs belonging to the cluster, in step 1002, each AT obtains the signal weight vector f and the main interference weight vector {dᵢ}_{i=1,2} by using Equation (16) in order to operate in C-BF technology. Also, the AT obtains the reception SINR to which collision avoidance BF (CA-BF) is applied and the reception SINR to which CA-BF is not applied, respectively. The AT feeds back the reception SINR corresponding to CA-BF as CA-BF CQI, and feeds back a difference between the CA-BF CQI and the reception SINR not corresponding to CA-BF as CA-BF delta CQI to the BTS. Also, in order to operate in C-SDMA technology by adding minimum feedback information to the feedback information used for C-BF, each AT calculates the reception SINR of one data stream received at the AT by the main signal weight vector f when the BTS to which the AT belongs uses a precoding matrix including the main signal weight vector f and each interference C-BTS does not use a precoding matrix including the main interference weight vector dᵢ for each C-BTS. That is, each AT calculates the reception SINR of one data stream received at the corresponding AT when a combination of a precoding matrix including the main signal weight vector and a precoding matrix not including the main interference weight vector in the precoder codebook F is used as the cluster transmission mode for C-SDMA. In order to calculate the reception SINR, each AT averages interference quantities received from (G−1) precoding matrices not including the main interference weight vector from among G precoding matrices belonging to F, and thereby obtains the average interference quantity received from each interference C-BTS. Each AT subtracts the reception SINR for C-SDMA, obtained in this way, from the reception SINR for C-BF to obtain C-SDMA delta CQI, and feeds back the obtained C-SDMA delta CQI to the BTS. Also, in step 1003, each AT transmits information on the main signal weight vector f and the main interference weight vector {dᵢ}_{i=1,2}, CA-BF CQI and CA-BF delta CQI for C-BF operation, and C-SDMA delta CQI for C-SDMA operation to the BTS over an uplink feedback channel.

Referring to FIG. 11, in step 1101, a BTS delivers feedback information from ATs to the cluster scheduler. In step 1102, the cluster scheduler calculates data capacity transmittable through C-BF for all C-AT combinations, and performs collision avoidance BF scheduling to determine a C-AT combination having the maximum transmission capacity and BF weights to be used by the corresponding combination. The collision avoidance BF scheduling is the same as described above in connection with C-BF technology. Also, in step 1003, the cluster scheduler calculates data capacity transmittable through C-SDMA for all C-AT combinations, and determines a C-AT combination having the maximum transmission capacity and the cluster transmission mode for C-SDMA, to be used by the corresponding combination. For example, supposing that there are two C-BTSs, each including two C-ATs, a total of two C-AT combinations exist. Using main signal weight vector information and main interference weight vector information fed back by each AT, the cluster scheduler determines if a precoding matrix including the signal weight vector of one AT of each C-AT combination coincides with a precoding matrix including the main interference weight vector of an AT belonging to another C-BTS. When these precoding matrices coincide with each other, it is impossible to operate in C-SDMA, and thus transmission capacity in C-SDMA cannot be calculated. Therefore, the cluster scheduler determines to operate in C-BF, which provides high transmission capacity. Such determination is made when the number of C-ATs is small, and in this case, it is preferred to operate in C-BF because capacity in C-SDMA is lower than that in C-BF.

When the precoding matrix including the signal weight vector of one AT does not coincide with the precoding matrix including the main interference weight vector of the AT belonging to another C-BTS, it is possible to operate in C-SDMA, and thus the cluster scheduler obtains the reception SINR for C-SDMA by subtracting C-SDMA delta CQI from CA-BF CQI, and calculates system capacity in C-SDMA by using the obtained reception SINR.

In step 1104, the cluster scheduler compares the maximum system transmission capacity in C-BF, determined in step 1102, with the maximum system capacity in C-SDMA, determined in step 1103, and selects technology providing higher system transmission capacity from among C-BF and C-SDMA.

In step 1105, the cluster scheduler transmits ATs to which data is to be transmitted from each BTS, BF weights or precoding matrices to be used by the corresponding ATs, and MCS information for data to be transmitted using the corresponding BF weights or transmission modes to each BTS. In step 1106, the corresponding BTS transmits data according to the information delivered from the cluster scheduler.

In this way, the hybrid C-SDMA/C-BF scheme makes it possible to adaptively operate in C-SDMA technology in the environment where the number of C-ATs is large and strong interference is received from interference BTSs by adding only a little feedback information to C-BF technology. Contrarily, when the number of C-ATs is small, it is possible to operate in C-BF, and thus high system transmission capacity can be provided in various environmental conditions.

As described above, the present invention can effectively suppress inter-cell interference only by using partial channel information delivered from an AT over a limited uplink feedback channel in a collaborative wireless communication system employing an FDD scheme, thereby considerably improving system transmission capacity for ATs located at cell edges.

Further, collaborative SDMA technology proposed in the present invention is a scheme in which data transmission by a single BTS is extended to data transmission by multiple collaborative BTSs in precoder codebook-based SDMA technology, and can be applied to both NC-ATs existing in the exclusive service area of a single BTS and C-ATs existing in a region where service areas of multiple BTSs overlap. Thus, it is completely compatible with the existing precoder codebook-based SDMA technology.

Further, the scheme to select a cluster transmission mode maximizing SINR at each link from among cluster transmission modes prearranged between a BTS and an AT, and the scheme to perform scheduling for ATs selecting the same cluster transmission mode according to respective cluster transmission modes and select a transmission mode providing the highest priority and ATs to which data is to be transmitted, proposed in the present invention, can improve cluster transmission capacity by using minimum feedback information to maximize multiuser diversity gain.

Further, the single cluster transmission mode selection and feedback scheme and the scheme to select and feed back G cluster transmission modes, proposed in the present invention, makes it possible to select the optimal feedback scheme for collaborative SDMA according to uplink feedback channel capacity allowed in the system.

Further, C-BF technology proposed in the present invention uses information on the weight vector used for signal transmission and the main interference weight vector, which is delivered over a limited uplink feedback channel, to suppress collision between formed by weights that each BTS uses, thereby improving system transmission capacity for ATs located at cell edges in a collaborative wireless communication system employing an FDD scheme.

Further, the hybrid C-SDMA/C-BF scheme proposed in the present invention makes it possible to adaptively select technology providing higher system capacity from among C-SDMA and C-BF by using limited feedback information, depending on the number of C-ATs and channel environment from interference BTSs, thereby providing high system capacity in various environmental conditions.

While the invention has been shown and described with reference to a certain exemplary embodiment thereof, it will be understood by those skilled in the art that various changes in form and details may be made therein without departing from the spirit and scope of the invention as defined by the appended claims and equivalents thereof.

What is claimed is:

1. A method of receiving downlink data in a collaborative wireless communication system using a multiple-input multiple-output (MIMO) antenna array, the method comprising the steps of:
estimating a downlink channel from a plurality of base stations belonging to the same cluster;
selecting a transmission mode used by the respective base stations, which maximizes a signal-to-noise ratio in the estimated downlink channel, and feeding back the selected transmission mode and the signal-to-noise ratio in the case of using the selected transmission mode to a corresponding base station; and
receiving the downlink data in the selected transmission mode from the corresponding base station.

2. The method as claimed in claim 1, wherein the step of selecting the transmission mode comprises the step of selecting a precoding matrix combination, which maximizes multiuser diversity gain, from among all possible precoding matrix combinations in a precoder codebook including G precoding matrices.

3. The method as claimed in claim 2, wherein the transmission mode comprises a precoding matrix combination that maximizes channel gain at a link to a base station from which to receive the downlink data, and minimizes interference from base stations transmitting interference signals.

4. The method as claimed in claim 1, wherein when an access terminal receives the downlink data from multiple base stations, information indicating that the access terminal feeds back G transmission modes, and information indicating the number of the base stations transmitting the downlink data for the access terminal are further fed back in the step of feeding back the transmission mode and the signal-to-noise ratio.

5. The method as claimed in claim 1, wherein when an access terminal receives the downlink data from multiple base stations, one transmission mode is selected for each of the multiple base stations, and the selected transmission mode is fed back to each of the base stations in the step of feeding backs the transmission mode and the signal-to-noise ratio.

6. A method of transmitting downlink data in a collaborative wireless communication system using a multiple-input multiple-output (MIMO) antenna array, the method comprising the steps of:
receiving feedback information from access terminals;
grouping the access terminals into access terminal groups, each of which includes the access terminals using the same transmission mode, by using transmission modes included in the feedback information, and performing scheduling for each access terminal group;
selecting an access terminal group with highest priority determined according to the scheduling, and determining a transmission mode to be used by the access terminals belonging to the selected access terminal group, and a modulation level of the downlink data to be transmitted to the access terminals of the selected access terminal group; and
transmitting the downlink data to the access terminals of the selected access terminal group according to the determined transmission mode and modulation level.

7. The method as claimed in claim 6, wherein the transmission mode comprises a precoding matrix combination that maximizes multiuser diversity gain from among all possible precoding matrix combinations in a precoder codebook including G precoding matrices.

8. The method as claimed in claim 7, wherein the transmission mode comprises a precoding matrix combination that maximizes channel gain at a link to a base station from which to receive the downlink data, and minimizes interference from base stations transmitting interference signals.

9. The method as claimed in claim 6, wherein the step of performing the scheduling comprises the step of determining priority according to a signal-to-noise ratio with which the corresponding access terminal receives the downlink data through the transmission mode and a transmission weight.

10. The method as claimed in claim 6, wherein information indicating that the corresponding access terminal feeds back G transmission modes, and information indicating the number of base stations transmitting the downlink data for the access terminal are further received in the step of receiving the feedback information.

11. A method of receiving downlink data in a collaborative wireless communication system using a multiple-input multiple-output (MIMO) antenna array, the method comprising the steps of:
estimating a downlink channel from base stations belonging to the same cluster;
determining a beamforming signal weight of a base station, which maximizes a reception signal-to-noise ratio in the estimated downlink channel, and beamforming interference weights of interference base stations, which maximize interference from the interference base stations;
feeding back the determined beamforming signal weight and beamforming interference weights and the reception signal-to-noise ratio to a corresponding base station; and
receiving the downlink data according to the determined beamforming signal weight from the corresponding base station.

12. The method as claimed in claim 11, wherein the reception signal-to-noise ratio comprises a reception signal-to-noise ratio occurring when collision between beams formed by beamforming signal weights that the respective base stations use is avoided.

13. The method as claimed in claim 12, wherein a difference value between the reception signal-to-noise ratio occurring when the collision between the beams is avoided and a reception signal-to-noise ratio occurring when the collision between the beams is not avoided is further fed back in the step of feeding back the determined beamforming signal weight and beamforming interference weights and the reception signal-to-noise ratio.

14. The method as claimed in claim 11, wherein when the base station uses two or more beamforming signal weights, the beamforming signal weights are grouped into signal weight groups, and are fed back in units of the signal weight groups in the step of feeding back the determined beamforming signal weight and beamforming interference weights and the reception signal-to-noise ratio.

15. A method of transmitting downlink data in a collaborative wireless communication system using a multiple-input multiple-output (MIMO) antenna array, the method comprising the steps of:
determining scheduling priority of access terminals by using signal-to-noise ratios included in feedback information received from the access terminals;
performing scheduling in such a manner as to minimize interference between base stations by using the determined priority and by using a beamforming signal weight of a base station and beamforming interference weights of interference base stations, included in the feedback information;
selecting an access terminal to which to transmit the downlink data, and determining a beamforming signal weight and a modulation level to be used by the selected access terminal; and
transmitting the downlink data to the selected access terminal according to the determined beamforming signal weight and modulation level.

16. The method as claimed in claim 15, wherein the step of determining the scheduling priority comprises the step of calculating transmittable data capacity for the access terminals, and determining the scheduling priority according to the calculated transmittable data capacity.

17. The method as claimed in claim 16, wherein when a beamforming signal weight received from one access terminal does not coincide with beamforming interference weights of other access terminals, the transmittable data capacity is calculated using channel quality information that avoids collision between beams formed from the base stations, and when a signal received from one access terminal coincides with beamforming interference weights of other access terminals, the transmittable data capacity is calculated using a signal-to-noise ratio occurring when collision between beams formed from the base stations is not avoided.

18. The method as claimed in claim 15, wherein the signal-to-noise ratio comprises a signal-to-noise ratio occurring when collision between beams formed by beamforming signal weights that the respective base stations use is avoided.

19. The method as claimed in claim 18, wherein the feedback information further comprises a difference value between the signal-to-noise ratio occurring when the collision between the beams is avoided and a signal-to-noise ratio occurring when the collision between the beams is not avoided.

20. An access terminal apparatus for receiving downlink data from a base station in a collaborative wireless communication system using a multiple-input multiple-output (MIMO) antenna array, the apparatus comprising:
a downlink channel estimator for estimating downlink channels received from base stations belonging to the same cluster;
a determiner for selecting a transmission mode maximizing a signal-to-noise ratio or a beamforming signal weight of a base station, which maximizes the signal-to-noise ratio, and beamforming interference weights of interference base stations, which maximize interference from the interference base stations, according to a result of estimation by the downlink channel estimator; and
a feedback transmitter for transmitting information determined by the determiner to the base station over an uplink feedback channel.

21. A base station apparatus for transmitting downlink data to access terminals in a collaborative wireless communication system using a multiple-input multiple-output (MIMO) antenna array, the apparatus comprising:
a feedback receiver for receiving feedback information from the access terminals over an uplink channel;
a scheduler for grouping the access terminals into access terminal groups, each of which includes the access terminals using the same transmission mode, by using transmission modes included in the feedback information, performing scheduling for each access terminal group or performing scheduling in such a manner as to minimize interference between base stations by using a beamforming signal weight of a base station and beamforming interference weights of interference base stations, included in the feedback information, selecting an access terminal group with highest priority determined according to the scheduling, and determining a transmission mode or a beamforming signal weight to be used by the access terminals belonging to the selected access terminal group, and a modulation level of the downlink data to be transmitted to the access terminals of the selected access terminal group; and
a data transmitter for transmitting the downlink data to the access terminals of the selected access terminal group according to the determined transmission mode or beamforming signal weight and modulation level determined by the scheduler.

22. The base station apparatus as claimed in claim 21, wherein the scheduler compares transmittable data capacity as a result of scheduling using the transmission mode with transmittable data capacity as a result of scheduling using the beamforming signal weight, and determines the modulation level of the data to be transmitted to the access terminals, based on the result of scheduling, which provides higher transmittable capacity as a result of comparison.
